(19) United States
(12) Patent Application Publication
(10) Pub. No.: US 2013/0018895 A1
(43) Pub. Date: Jan. 17, 2013

(54) SYSTEMS AND METHODS FOR EXTRACTING MEANING FROM SPEECH-TO-TEXT DATA

(71) Applicants: William G. Harless, Bethesda, MD (US); Michael G. Harless, Rockville, MD (US); Marcia A. Zier, Bethesda, MD (US)

(72) Inventors: William G. Harless, Bethesda, MD (US); Michael G. Harless, Rockville, MD (US); Marcia A. Zier, Bethesda, MD (US)

(21) Appl. No.: 13/547,967

(22) Filed: Jul. 12, 2012

Related U.S. Application Data
(60) Provisional application No. 61/506,998, filed on Jul. 12, 2011.

(51) Int. Cl. G06F 17/30

(52) U.S. Cl. 707/748; 707/E17.014

(57) ABSTRACT

Systems and methods are provided for simulating an interactive conversation with a recorded subject. In accordance with an implementation, a server receives a text string corresponding to a query spoken by a user during the interactive conversation, and subsequently obtains information associated with a plurality of candidate queries posed to the recorded subject. The obtained information may include, for corresponding ones of the candidate queries, a primary keyword, at least one of a contextual keyword or a qualifier keyword associated with the primary keyword, and synonym data. The server may generate scores for the candidate queries based on the text string and at least one of the keyword data or the synonym data. Based on the candidate query scores, the server may select one of the candidate queries that corresponds to the text string and video content that responds to the spoken query.

### CROSS-REFERENCE TO RELATED APPLICATIONS

This application claims the benefit of priority to U.S. Provisional Patent Application No. 61/506,998, filed Jul. 12, 2011, the disclosure of which is expressly incorporated herein by reference in its entirety.

### GOVERNMENT LICENSE RIGHTS

This invention was made with government support under Contract No. HHSN276201000510P (in conjunction with SBIR Grant No. DAAH01-00-CR137) awarded by the U.S. National Institutes of Health. The U.S. government may have certain rights in the invention

### BACKGROUND

1. Technical Field

The present disclosure generally relates to systems and methods for initiating and conducting a sustained, free-speech, simulated conversation with pre-recorded video images of a subject. More particularly, and without limitation, the present disclosure relates to systems and methods that present users with video content in response to a spoken input within an interactive simulated conversation.

2. Background Information

Today, the laptop computers, smart phones, and tablet computers are capable of accepting spoken input, that is, audio input of human speech, and subsequently convert that spoken input into corresponding text strings. While these technologies adequately convert spoken words into corresponding English text, modern computing devices generally lack an ability to understand the meaning of a free speech inquiry.

### SUMMARY

Consistent with embodiments of the present disclosure, computer-implemented systems and methods are provided for simulating an interactive conversation with a recorded subject. In one exemplary embodiment, a method is provided that receives a text string corresponding to a query spoken by a user during the interactive conversation and obtains information associated with a plurality of candidate queries posed to the recorded subject. The information may include keyword data associated with the candidate queries, and the keyword data may include, for corresponding ones of the candidate queries, at least a primary keyword. The information may also include synonym data comprising a synonym for the primary keyword. Using at least one processor, scores are generated for the candidate queries based on the text string and at least one of the keyword data or the synonym data. The candidate query scores may be indicative of a correspondence between a portion of the text string and the candidate queries. The method selects, based on the candidate query scores, one of the candidate queries that corresponds to the text string, the selected candidate query being associated with video content that includes a response to the spoken query by the recorded subject.

Consistent with further embodiments of the present disclosure, a system is provided having a storage device and at least one processor coupled to the storage device. The storage device stores a set of instructions for controlling the at least one processor, and wherein the at least one processor, being operative with the set of instructions, is configured to receive a text string corresponding to a query spoken by a user during the interactive conversation and obtain information associated with a plurality of candidate queries posed to the recorded subject. The information may include keyword data associated with the candidate queries, and the keyword data may include, for corresponding ones of the candidate queries, at least a primary keyword. The information may also include synonym data comprising a synonym for the primary keyword. The information may also include synonym data comprising a synonym for at least one of the primary keyword, the contextual keyword, or the qualifier keyword. The at least one processor is configured to generate scores for the candidate queries based on the text string and at least one of the keyword data or the synonym data. The candidate query scores may be indicative of a correspondence between a portion of the text string and the candidate queries. The at least one processor is configured to select, based on the candidate query scores, one of the candidate queries that corresponds to the text string, the selected candidate query being associated with video content that includes a response to the spoken query by the recorded subject.

Other embodiments of the present disclosure relate to a tangible, non-transitory computer-readable medium that stores a set of instructions that, when executed by a processor, perform a method for simulating an interactive conversation with a recorded subject. The method includes receiving a text string corresponding to a query spoken by a user during the interactive conversation and obtaining information associated with a plurality of candidate queries posed to the recorded subject. The information may include keyword data associated with the candidate queries, and the keyword data may include, for corresponding ones of the candidate queries, at least a primary keyword. The information may also include synonym data comprising a synonym for the primary keyword. The information may also include synonym data comprising a synonym for at least one of the primary keyword, the contextual keyword, or the qualifier keyword. The method includes generating scores for the candidate queries based on the text string and at least one of the keyword data or the synonym data. The candidate query scores may be indicative of a correspondence between a portion of the text string and the candidate queries. The method selects, based on the candidate query scores, one of the candidate queries that corresponds to the text string, the selected candidate query being associated with video content that includes a response to the spoken query by the recorded subject.

It is to be understood that both the foregoing general description and the following detailed description are exemplary and explanatory only, and are not restrictive of the invention as claimed. Further, the accompanying drawings, which are incorporated in and constitute a part of this specification, illustrate embodiments of the present disclosure and together with the description, serve to explain principles of the invention as set forth in the accompanying claims.

### BRIEF DESCRIPTION OF THE DRAWINGS

FIG. 1 is a diagram of an exemplary computing environment within which embodiments of the present disclosure may be practiced.

FIGS. 2A-2C are diagrams illustrating exemplary white lists, black lists, and endings lists consistent with disclosed embodiments.

FIG. 3 is a diagram of an exemplary computer system, consistent with disclosed embodiments.

FIG. 4 is a flowchart of an exemplary method for initiating and conducting an interactive simulated conversation with a pre-recorded subject, according to disclosed embodiments.

FIG. 5 is a flowchart of an exemplary method for identifying video content that matches a content and meaning of a spoken statement, according to disclosed embodiments.

FIG. 6 is a flowchart of an exemplary method or parsing a text string, according to disclosed embodiments.

FIG. 7 is a flowchart of an exemplary method for identifying candidate text strings representing potential matches for a parsed text string, according to disclosed embodiments.

FIG. 8 is a flowchart of an exemplary method for generating scores for candidate queries, according to disclosed embodiments.

FIGS. 9A and 9B illustrate exemplary outputs of a candidate query scoring process, according to disclosed embodiments.

### DESCRIPTION OF THE EMBODIMENTS

Reference will now be made in detail to embodiments of the present disclosure, examples of which are illustrated in the accompanying drawings. The same reference numbers will be used throughout the drawings to refer to the same or like parts.

In this application, the use of the singular includes the plural unless specifically stated otherwise. In this application, the use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, the section headings used herein are for organizational purposes only, and are not to be construed as limiting the subject matter described.

In accordance with the disclosed exemplary embodiments, “machine understanding” is the ability to calculate a result that leads to a right action. “Human understanding” implies life experiences, intuition, imagination and cognition, usually in concert. The disclosed exemplary embodiments enhance “machine understanding” to give it the appearance of having “human understanding” in a sustained free-speech conversation with a human being. The disclosed exemplary embodiments are further designed to use the mathematical method of combinations and permutations to allow the machine to estimate the intention of the user's spoken phrase and provide an immediate, precise, relevant response. Further, the disclosed exemplary embodiments allow for a sustained, free-speech conversation of unlimited duration between a human being and a machine.

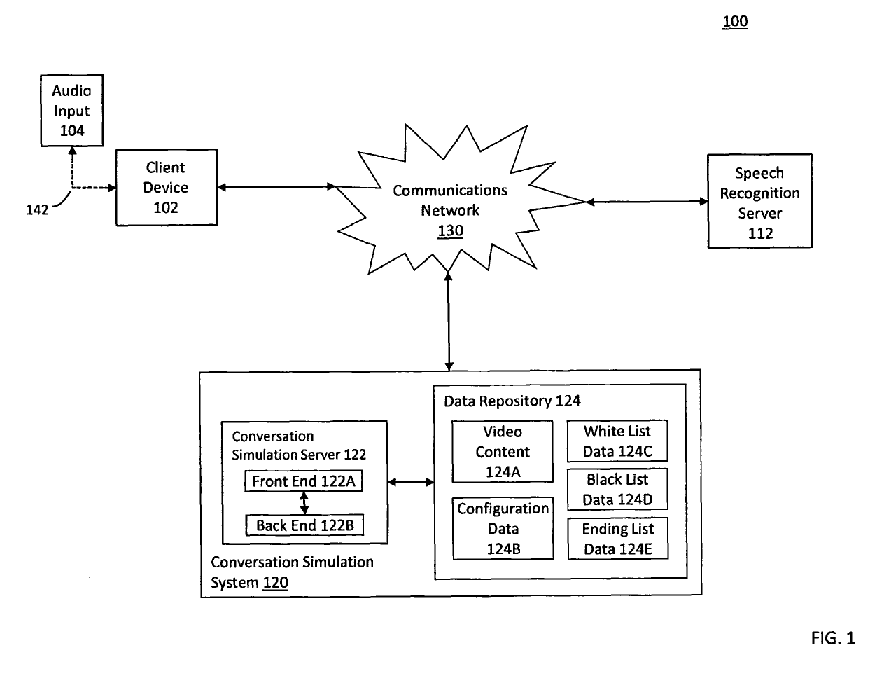

FIG. 1 illustrates an exemplary computing environment 100 within which embodiments consistent with the present disclosure may be practiced. In FIG. 1, a conversation simulation system 120, a client device 102, and a speech recognition server 112 are interconnected via a communications network 130. As further disclosed herein, conversation simulation system 120, client device 102, and speech recognition server 112 may exchange information across network 130 to facilitate an interactive simulated conversation between a user of client device 102 and images of a pre-recorded subject.

In an embodiment, client device 102 can be implemented with a processor or computer-based system capable of receiving audio input from a user and subsequently rendering and displaying interactive video content responsive to the audio input. For example, client device 102 can include, but is not limited to, a personal computer, a laptop computer, a notebook computer, a hand-held computer, a personal digital assistant, a portable navigation device, a mobile phone, a smart phone, and a set top box, an optical disk player (e.g., a DVD player), and/or a digital video recorder (DVR) in communication with a display unit. Client devices consistent with the disclosed embodiments are not limited to such exemplary computing devices, and in additional embodiments, client device 102 may include any additional or alternate computing device operable to receive audio input and display video content corresponding to an interactive, simulated conversation with a recorded subject.

Client device 102 may be in communication with an audio input device 104 through connection 142. For example, audio input device 102 may include, but is not limited to, a handheld microphone, a headset that includes a microphone, or any additional or alternate device that enables a user of client device 102 to provide spoken audio input to client device 102. Further, for example, connection 142 may include, but is not limited to, a wired connection through a USB port, a wired connection through a dedicated interface of client device 102, a wireless connection (e.g., Bluetooth or near-field communications), or any additional or alternate connection type apparent to one of skill in the art and appropriate to client device 102 and audio input device 104. Furthermore, although described in terms of an external device having a corresponding connection, audio input devices consistent with the disclosed embodiments may also include audio input devices integrated into client device 102, e.g., a microphone integrated into a laptop, smart phone, or tablet computing device.

Communications network 130 may represent any form or medium of digital data communication. Examples of communication network 130 include a local area network (“LAN”), a wireless LAN, e.g., a “WiFi” network, a wireless Metropolitan Area Network (MAN) that connects multiple wireless LANs, and a wide area network (“WAN”), e.g., the Internet. Consistent with embodiments of the present disclosure, network 120 may comprise the Internet and include any publicly-accessible network or networks interconnected via one or more communication protocols, including, but not limited to, hypertext transfer protocol (HTTP) and transmission control protocol/internet protocol (TCP/IP). Moreover, communications network 130 may also include one or more mobile device networks, such as a GSM network or a PCS network, that allow user devices, such as user device 102, to send and receive data via applicable communications protocols, including those described above.

Conversation simulation system 120 may include a conversation simulation server 122 and a data repository 124. In FIG. 1, conversation simulation server 122 includes a front end 122A and a back end 122B, which is disposed in communication with front end 122A. In the exemplary embodiment of FIG. 1, front end 122A and back end 122B of conversation simulation server 122 may be incorporated into a hardware unit, for example, a single computer, a single server, or any additional or alternate computing device apparent to one or skill in the art. Further, in such an exemplary embodiment, front end 122A may be a software application, such as a web service, executing on conversation simulation server 122. However, conversation simulation server 122 is not limited to such configurations, and, in additional embodiments, front end 122A may be executed on any computer or server separate from back end 122B.

In an embodiment, conversation simulation system 120 may facilitate an interactive, simulated conversation between a user of client device 102 and one or more pre-recorded subjects. For example, the pre-recorded subjects may include, but are not limited to, pioneering scientists, physicians, educators, and politicians (e.g., Senator John Glenn, former Surgeon General C. Everett Koop, Dr. Donald Lindberg, who heads the U.S. National Library of Medicine, Dr. Anthony Fauci, the director of the National Institute of Allergy and Infectious Diseases, and Dr. Marshall Nirenberg, which received a Nobel Prize in 1968 for deciphering the genetic code).

The disclosed embodiments are, however, not limited to such exemplary subjects. In additional embodiments, subjects of the interactive simulated conversations may include participants in events of cultural significance (e.g., Holocaust survivors and participants in the civil rights marches of the 1960s), individuals having practical or specialized experience of interest to a community (e.g., physicians, engineers, mathematicians, and mechanics), elderly relatives, and any additional or alternate individuals whose experience or practical knowledge is of interest to the user of client device 102.

For example, a simulated conversation with a subject (e.g., Dr. Donald Lindberg) may be based on a library of pre-recorded video content of the subject answering various posed questions. For example, an interviewer may ask Dr. Lindberg questions related to his tenure at the U.S. National Library of Medicine (NLM) (e.g., “How long have you been the Director at NLM?”). Dr. Lindberg's response to the question may be filmed in a manner that captures not only the answer to the question, but also, Dr. Lindberg's physical responses and cues while he answers the question. In such an embodiment, the resulting video content, when viewed by a use of client device 102, provides not only the answer to the question, but also a belief by the viewer that he is interacting with and actually speaking to Dr. Lindberg.

In such embodiments, the questions posed to a subject (e.g., Dr. Lindberg) may include questions directed to the subject's background, family, education, current career position, personal or professional achievement, profession colleagues, hobbies, personal or political belief, and any additional or alternate information of potential interest to a community of users. Further, in these embodiments, the questions posed to a subject may be associated with a hierarchical structure. For example, an initial question regarding Dr. Lindberg's tenure at the NLM may be followed by questions related to the tenure of prior directors, whether or not he communicates with prior directors, and/or names of prior directors.

Referring back to FIG. 1, information associated with the pre-recorded video content of the various subjects may be stored within data repository 124 of conversation simulation system 120. As depicted in FIG. 1, data repository 124 includes video content 124A that stores, for each subject of a interactive simulated conversation, discrete segments of video content that represent, respectively, the subject's response to corresponding ones of the posed questions. For example, video content 124A may include a segment of video content that records Dr. Lindberg's answer to the question related to his tenure at NLM, and additional segments of video content that record Dr. Lindberg's answer to each and every other question posed to him during the interview. Virtual dialog interviews consistent with the disclosed embodiments typically may last for over an hour.

Data repository 124A also includes configuration data 124B. In an embodiment, configuration data 124B may store, for each subject of an interactive simulated conversation, entries that identify queries posed to the subjects and that are linked to corresponding video segments in video content 124A. For example, the question “How long have you been the Director at NLM,” which was posed to Dr. Lindberg, may be associated with a single entry in configuration data 124B that is linked to a corresponding video segment within video content data 124A.

In addition to identifying a corresponding query, an entry in configuration data store 124B may also include keyword data directed to the corresponding query and synonym data associated with the keyword data. For example, text of the corresponding query may be decomposed into a primary keyword or phrase (i.e., a PKW) that reveals a topic of theme associated with the query considered by the subject. For example, the PKW for the query “How long have you been the Director at NLM” is “Director.”

Further, the keyword data may also include a qualifier keyword or phrase (i.e., a QKW) that clarifies an intention associated with the PKW and that enables the subject to more fully answer the posed query, and a contextual keyword or phrase (i.e., a CKW) that defines a boundary of the query and that may increase a precision with which the subject understands the query. For example, in the statement “How long have you been the Director at NLM,” the QKW corresponds to the phrase “how long” and the CKW corresponds to “NLM.”

The keyword data for a particular entry and corresponding query may further include phrases constructed from various combinations of the PKW, CKW, and QKW with other words within the question. For example, the keyword data associated with a particular query may include a combination of the words and phrases of the corresponding PKW, QKW, and/or CKW (i.e., a PQC combination). Such a combination of words and phrases, upon arrangement, may provide a depiction of an intention of an individual who posed the query and a meaning imparted by the individual onto the query. For example, in an entry corresponding to the query “How long have you been the Director at NLM,” the PQC combination would be “how long director NLM.”

The keyword data for a particular query may also include contiguous phrases that include the PKW and words disposed immediately before and after the PKW in the query. In such an embodiment, discussed below, unauthorized words having fewer than three letters are ignored, and a contiguous phase corresponding to the query “How long have you been the Director at NLM” takes the form “been director NLM.” The contiguous phrases of the keyword data may also include two-word subsets of the contiguous phrases that include the PKW, e.g., “been director” and “director NLM.

Further, phrases within the keyword may also represent full-parsed phrases that include a query, processed to discard all unauthorized words having fewer than three characters, and two-word subsets of the processed query that include the PKW and the CKW. For example, for the query “How long have you been the Director at NLM,” the corresponding full-parsed phrase is represented by “how long have you been director NLM,” assuming the three-letter words “you” and “how” are authorized words. Further, the two-word subsets include, for example, “how director,” “long director,” “have director,” “you director,” “been director,” “how NLM,” “long NLM,” “have NLM,” “you NLM,” and “been NLM,” where “director” is the PKW and “NLM” is the CKW.

As described above, an entry of the configuration data store 124B corresponding to a particular query may include synonym data associated with the at least one of the PKW, CKW, or QKW of the particular query. In such embodiments, the synonym data may include combinations of synonyms of the PKW and CKW of the particular query (i.e., a P/C synonym mix) and combinations of synonyms of the PKW and QKW of the particular query (i.e., a P/Q synonym mix). As described below, conversation simulation system 120 may leverage the combinations and permutations of keywords and synonyms within configuration data 124B to identify questions and corresponding video segments that are consistent with an intended meaning of “free speech” queries uttered by one or more users.

In the embodiments described above, configuration data store 124B may store keyword data and synonym data for each query posed to a plurality of subjects of an interactive, simulated conversation. For example, an administrator of conversation simulation system 120 may access conversation simulation server 122 using a corresponding web page or other graphical user interface, and may subsequently parse the queries to manually generate and store the PKW, CKW, and QKW for each query, and additionally or alternatively, to identify synonyms associated with the PKW, CKW, and QKW. In such embodiments, the server may subsequently generate the contiguous phases, the full-parsed phrases, and the synonym combinations outlined above, which may be stored with the corresponding query in configuration data 124B.

The disclosed embodiments are not limited to such exemplary techniques that generating PKWs, QKWs, and CKWs. In additional embodiments, the administrator may access the interface associated with server 122 to submit a query posed to a subject, and server 122 may algorithmically parse the submitted query to algorithmically generate the PKW, QKW, and CKW using, for example, one or more machine-learning techniques, collaborative learning techniques, artificial intelligence techniques, or any additional or alternate techniques appropriate to the submitted text string.

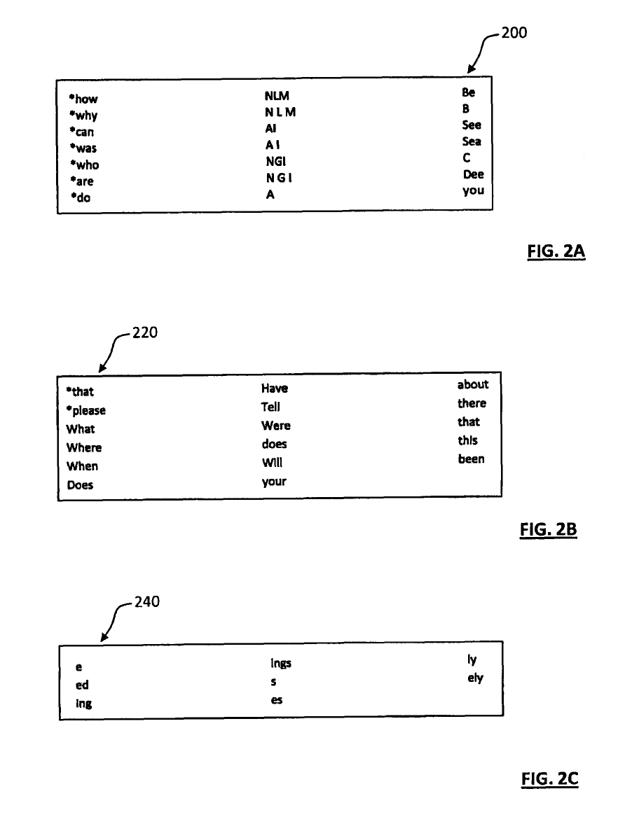

Referring back to FIG. 1, data repository 124 may also include white list data 124C, black list data 124D, and ending list data 124E that may be leveraged by conversation simulation server 122 to parse queries posed to subjects or queries uttered by users of conversation simulation system 120. In an embodiment, white list data 124C may include information that identifies authorized words that include less than three characters, as depicted in FIG. 2A. Further, white list 200 also includes words that are conditionally protected depending on their locations within a text string. For example, in white list 200, an asterisk disposed before an entry indicates that the entry will be retained only if disposed in an initial position within the text string. In such embodiments, when applying white list 200 to parse the query “How long have you been the Director at NLM,” the words “NLM,” “how,” and “you” would be retained within the parsed query, while the words “the” and “at” would be discarded due to their length.

Black list data 124D may include information that identifies words possessing little or no value in interpreting a meaning of a query, e.g., interrogative words, as depicted in FIG. 2B. For example, black list data 220 of FIG. 2B identifies words in a query that provide little or no information on a meaning or intention imparted by a user. Further, in black list 220, an asterisk disposed before an entry (e.g., “please”) indicates that the entry will be retained in a query when that entry corresponds to a command word and will not be discarded from a query. In such embodiments, when applying black list 220 to parse the query “How long have you been the Director at NLM,” the words “have” and “been” would be discarded from the query because they provide no information on the query's meaning.

Further, data repository 124 may include endings list data 124E that identifies one or more endings that are removed from words of a query to, for example, clarify a meaning of the corresponding roots and facilitate the comparison of the query to spoken queries provided by a user. In such embodiments, depicted in FIG. 2C, an endings list 240 may be applied to the query “How long have you been the Director at NLM” to replace the word “have” with a corresponding root “hay.”

In the embodiments described above, one or more of configuration data 124B, white list data 124C, black list data 124D, and endings list data 124E may be stored within data repository 124 using an appropriate mark-up language, such as XML. The disclosed embodiments are not limited to such exemplary storage formats, and in additional embodiments, configuration data 124B, white lists data 124C, black list data 124D, and endings lists data 124E may be stored within data repository 124 using any additional or alternate storage format apparent to one of skill in the art and appropriate to conversation simulation server 122.

Referring back to FIG. 1, speech recognition server 112 may comprise a general purpose computer (e.g., a personal computer, network computer, server, or mainframe computer) having one or more processors that may be selectively activated or reconfigured by a computer program to perform communications protocol processing. In additional embodiments, speech recognition server 112 may be incorporated as a node in a distributed network. For example, speech recognition server 122 may communicate via network 130 with one or more additional servers (not shown), which may enable speech recognition server 122 to distribute processes for parallel execution by a plurality of other servers.

Further, although not depicted in FIG. 1, speech recognition server 112 may include a front end and a back end, which may be disposed in communication with the front end. For example, such front and back ends may be incorporated into a hardware unit, for example, a single computer or a single server. In such an exemplary embodiment, the front end may be a software application, such as a web service, executing on speech recognition server 112. However, speech recognition server 112 is not limited to such exemplary configurations, and, in additional embodiments, a front end may be executed on any computer or server separate from the back end without departing from the spirit of scope of the present disclosed embodiments.

In an embodiment, speech recognition server 112 may be associated with a search engine (e.g., Google Speech Server), which may coordinate with a internet browser executed at client device 102 to receive audio data associated with a spoken utterance and the subsequent convert the audio data into corresponding text. In such an embodiment, a user of client device 102 may be accessing conversation simulation system 120 using a web browser or appropriate executable program, and the web browser or executable program may programmatically transfer the converted text data to conversation simulation system 112 for analysis and subsequent transfer to conversation simulation system 120.

The disclosed embodiments are, however, not limited to such exemplary processes for converting speech into corresponding text strings. In additional embodiments, client device 102 may execute an application program (e.g., Microsoft Speech Recognition) designed to accept audio input from the user, which may subsequently convert that audio input into a text string. In such an embodiment, the web browser or executable program at client device 102 may programmatically transfer the converted text string directly to conversation simulation system 120 for analysis.

Although computing environment 100 is illustrated in FIG. 1 with a single client device 102 in communication with conversation simulation system 120 and speech recognition server 120, persons of ordinary skill in the art will recognize that environment 100 may include any number of additional number of mobile or stationary client devices, any number of additional speech recognition servers, and any additional number of computers, systems, or servers without departing from the spirit or scope of the disclosed embodiments.

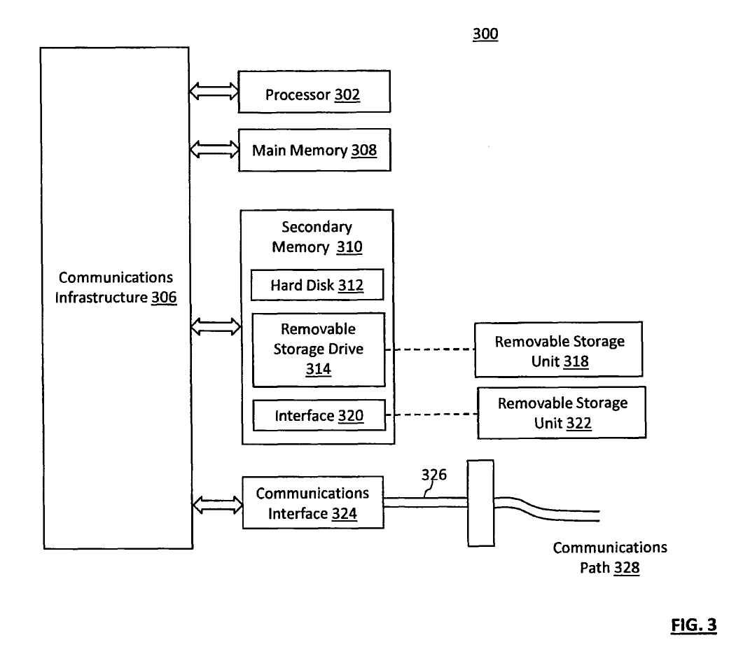

Furthermore, client device 102, speech recognition server 112, and conversation simulation server 122 may represent any type of computer system capable of performing communication protocol processing. FIG. 3 is an exemplary computer system 200, according to an embodiment of the invention. Computer system 300 includes one or more processors, such as processor 302. Processor 302 is connected to a communication infrastructure 306, such as a bus or network, e.g., network 130 of FIG. 1

Computer system 300 also includes a main memory 308, for example, random access memory (RAM), and may include a secondary memory 310. Secondary memory 310 may include, for example, a hard disk drive 312 and/or a removable storage drive 314, representing a magnetic tape drive, an optical disk drive, CD/DVD drive, etc. The removable storage drive 314 reads from and/or writes to a removable storage unit 318 in a well-known manner. Removable storage unit 318 represents a magnetic tape, optical disk, or other storage medium that is read by and written to by removable storage drive 314. As will be appreciated, the removable storage unit 318 can represent a computer-readable medium having stored therein computer programs, sets of instructions, code, or data to be executed by processor 302.

In alternate embodiments, secondary memory 310 may include other means for allowing computer programs or other program instructions to be loaded into computer system 300. Such means may include, for example, a removable storage unit 322 and an interface 320. An example of such means may include a removable memory chip (e.g., EPROM, RAM, ROM, DRAM, EEPROM, flash memory devices, or other volatile or non-volatile memory devices) and associated sockets, or other removable storage units 322 and interfaces 320, which allow instructions and data to be transferred from the removable storage unit 322 to computer system 300.

Computer system 300 may also include one or more communications interfaces, such as communications interface 324. Communications interface 324 allows software and data to be transferred between computer system 300 and external devices. Examples of communications interface 324 may include a modem, a network interface (e.g., an Ethernet card), a communications port, a PCMCIA slot and card, etc. Software and data may be transferred via communications interface 324 in the form of signals 326, which may be electronic, electromagnetic, optical or other signals capable of being received by communications interface 324. These signals 326 are provided to communications interface 324 via a communications path (i.e., channel 328). Channel 328 carries signals 326 and may be implemented using wire, cable, fiber optics, RF link, and/or other communications channels. In an embodiment of the invention, signals 326 comprise data packets sent to processor 302. Information representing processed packets can also be sent in the form of signals 326 from processor 302 through communications path 328.

The terms “storage device” and “storage medium” may refer to particular devices including, but not limited to, main memory 308, secondary memory 310, a hard disk installed in hard disk drive 312, and removable storage units 318 and 322. Further, the term “computer readable medium” may refer to devices including, but not limited to, a hard disk installed in hard disk drive 312, any combination of main memory 308 and secondary memory 310, and removable storage units 318 and 322, which respectively provide computer programs and/or sets of instructions to processor 302 of computer system 300. Such computer programs and sets of instructions can be stored within one or more computer readable media. Additionally or alternatively, computer programs and sets of instructions may also be received via communications interface 324 and stored on the one or more computer readable media.

Such computer programs and instructions, when executed by processor 302, enable processor 302 to perform the computer-implemented methods described herein. Examples of program instructions include, for example, machine code, such as code produced by a compiler, and files containing a high-level code that can be executed by processor 302 using an interpreter.

Furthermore, the computer-implemented methods described herein can be implemented on a single processor of a computer system, such as processor 302 of system 300. However, in additional embodiments, these computer-implemented methods may be implemented using one or more processors within a single computer system, and additionally or alternatively, these computer-implemented methods may be implemented on one or more processors within separate computer systems linked via a network.

As described above, computing environment 100 enables a user of a client device (e.g., client device 102) to communicate with conversation simulation system 120 and engage in an interactive simulated conversation with a pre-recorded subject that preserves a fidelity associated with person-to person conversations. For example, in an embodiment, the user need not select a query from a set of prompts, but may instead provide a freely-spoken query that responds to the conversation with the subject and corresponds to an interest of the user. In such embodiments, the pre-recorded subject provides meaningful responses to such freely-spoken queries, and engages the user (e.g., using eye contact and realistic physical gestures) to provide the user with a sense that he or she is in the presence of the recorded subject.

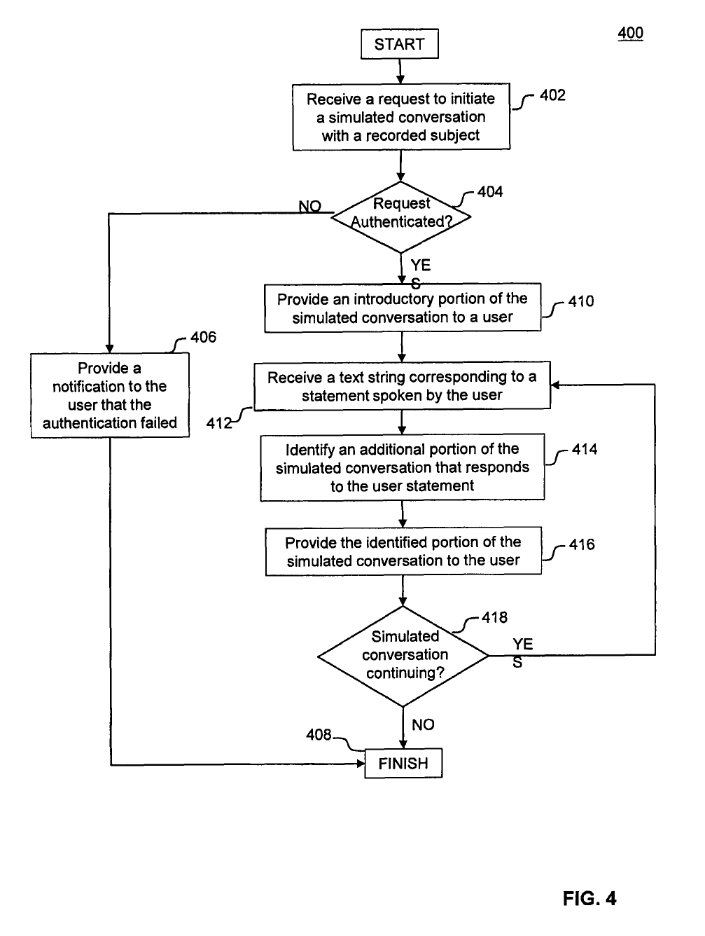

In such embodiments, a user of a client device (e.g., client device 102 of FIG. 1) may initiate an interactive simulated conversation with a desired subject by accessing a web page associated with conversation simulation system 120, or alternatively, by executing an application program associated with conversation simulation system 120. The user may subsequently enter a set of login credentials, and additionally or alternative, indicate a desired subject for the interactive simulated conversation. Upon entry of the login credentials, or alternatively, the selection of the desired subject, a request to initiate the simulated conversation with the desired subject may be programmatically transmitted over network 130 from client device 102 to conversation simulation system 120. Further, in an embodiment, the request may also include license information indicative of the user's ability to access conversation simulation system 120 and enter into the interactive simulated conversation. Upon receipt of the request, conversation simulation system 120 may process the received request to initiate and conduct the interactive simulated conversation with the user, as described below in reference to FIG. 4.

FIG. 4 is a flowchart of an exemplary method 400 for initiating and conducting an interactive simulated conversation between a user and a pre-recorded subject, according to disclosed embodiments. Method 400 may be implemented by a server of a conversation simulation system (e.g., server 122 of FIG. 1) to initiate an interactive simulated conversation with a user of a client device (e.g., client device 102 of FIG. 1) and subsequently conduct the simulated conversation in response to spoken inputs provided by the user. As will be apparent to one of skill in the art from the present disclosure, the steps and arrangement of the same in FIG. 4 may be modified, as needed.

In step 402, server 122 may receive a request to initiate the simulated conversation from the user of client device 102. As discussed above, the request may include one or more login credentials of the user (e.g., a user name or password), and may indicate a desired subject for the simulated conversation. Further, in additional embodiments, the request may also include license information associated with the user and/or client device 102.

Server 122 may authenticate the received request in step 404. For example, server 122 may determine that the received login credentials are valid, and additionally or alternatively, that the received license information is currently valid. If server 122 fails to authenticate the request in step 404, then a notification of the failed authentication is generated and provided to client device 102 over network 130 in step 406. Exemplary method 400 is then completed in step 408.

Alternatively, if server 122 authenticates the received request in step 404, then server 122 accesses a data repository (e.g., video content 124A of FIG. 1) to retrieve a video segment corresponding to an introductory portion of a simulated conversation with the desired subject, which may be provided in step 410 to client device 102 over network 130. Upon receipt of the introductory portion, client device 102 may render or otherwise process the introductory portion of the simulated conversation, which may be displayed to a user within a Flash media player, Windows media player, or using any additional or alternate means for displaying video content appropriate to the introductory portion and client device 102.

For example, the user of client device 102 may wish to initiate a simulated conversation with Dr. Donald Lindberg, the head of the U.S. National Library of Medicine. Upon authentication of a request to initiate the simulated conversation in step 404, server 122 may access video content 124A of data repository 124 to obtain a video segment that corresponds to an introductory portion of the simulated conversation with Dr. Lindberg. Server 122 may subsequently transmit the introductory video segment to client device 102 over network 130, and client device 102 may display the received video segment within a web browser or interface of an executable application, as described above.

For example, during the introductory video segment, Dr. Lindberg may introduce himself, provide a description of his current position, and some details of his educational and research background. While viewing the introductory video segment, the viewer may want Dr. Lindberg to expand on one or more of the topics mentioned during the introduction, or the user may want Dr. Lindberg to clarify a portion of his introduction. In such an embodiment, the user may employ a microphone or other audio input device associated with client device 102 (e.g., audio input device 104 of FIG. 1) to provide a spoken query to Dr. Lindberg.

In such an embodiment, client device 102 may receive the spoken query, and may convert the spoken query to a text string using one of a number of speech recognition programs (e.g., Microsoft Speech Recognition) executed locally on client device 102. Upon generation of the text query corresponding to the spoken query, client device 102 may transmit the generated text string to server 122. Alternatively, client device 102 may transmit information associated with the spoken to an external speech recognition engine (e.g., speech recognition server 112 of FIG. 1), which may convert the spoken query into a corresponding text string and provide the corresponding text string to server 122.

Server 122 may receive the text string corresponding to the spoken query in step 412, which may be processed in step 414 to identify an additional portion of the simulated conversation (e.g., video content) that includes a response to the spoken query. For example, in step 414, server 122 may parse the text string, identify segments of video content associated with candidate queries posed to the subject, generate scores for the candidate queries, and based on the scores, select one of the video segments associated with the candidate queries as the response to the spoken query.

For example, in response to Dr. Lindberg's introduction, the user of client device 102 may utter the following query into a microphone associated with client device 102:

“How long have you been the Director?”

Client device 102 may convert the audio input into a corresponding text string, or alternatively may transmit the audio input to a speech recognition server 112, which converts the transmitted audio signal into a corresponding text string.

Upon receipt of the text in step 412, server 122 may process the received text string to identify a query associated with an entry in the configuration data for Dr. Lindberg that represents a “best” match to both the words of the text string and the meaning imparted on these words by the text string. Server 122 may subsequently access video content 124A to obtain a segment of video content linked to the entry associated with identified query.

Referring back to FIG. 4, in step 416, server 122 may generate an instruction to transmit the identified segment of video content, and additionally or alternatively, information associated with the identified video content segment, to client device 102. For example, upon receipt of the segment of video content, client device 102 may present the content to the user in a manner consistent with a person-to-person conversation. In such embodiments, by maintaining the fidelity of person-to-person communications, the video dialog process is able to more fully engage the user and increase an impact and a utility of the simulated conversation.

In step 418, server 122 may determine whether the simulated conversation between the user and the previously-recorded subject continues. For example, the query spoken by the user may not represent a follow-up question to the subject's introductory remarks, but may instead represent a command statement requested an end to the conversation. In such embodiments, the segment of video content provided to client device 102 by server 122 in step 416 may represent the subject's concluding remarks.

In such an embodiment, server 122 may determine that the simulated conversation fails to continue in step 418. Additionally or alternatively, server 122 may identify an end to the simulated conversation in step 418 based on a period of inactivity by the user of client device 102 (e.g., the period of inactivity exceeding a threshold value), a lack of communications between client device 102 and server 122, or using any additional or alternate metric apparent to one of skill in the art.

Upon completion of the simulated conversation, exemplary method 400 is completed in step 408. Alternatively, if server 122 determines that the simulated conversation continues in step 418, the method 400 passes back to step 412, and server 122 awaits an additional text string corresponding to an additional query spoken by the user.

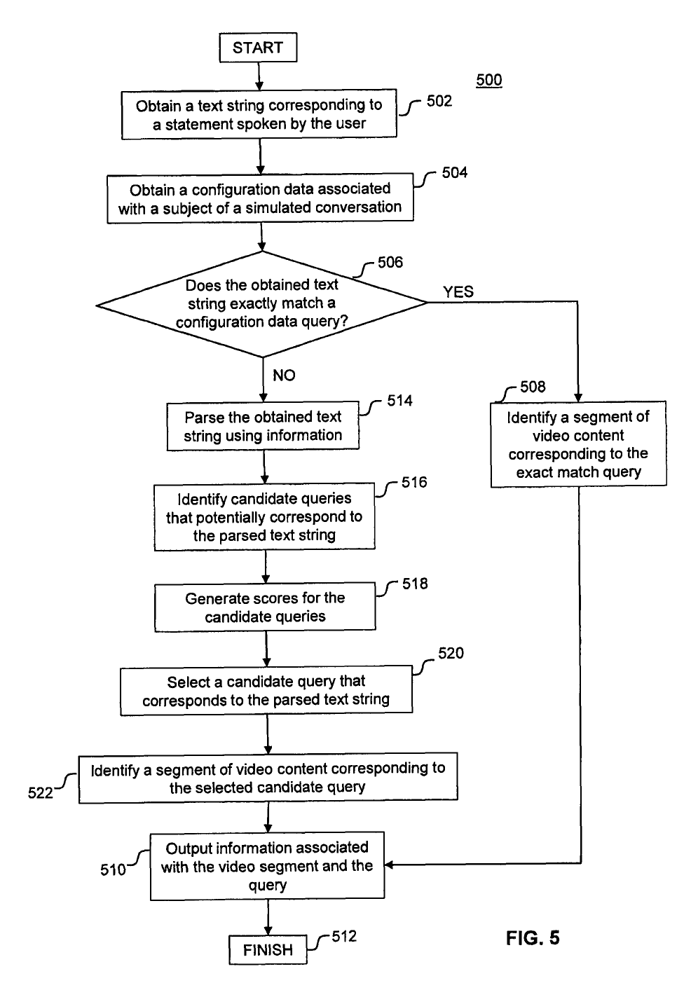

Using the exemplary methods of FIG. 4, a user of client device 102 may engage in an interactive, simulated conversation with a pre-recorded subject that preserves a fidelity associated with person-to person conversations. To facilitate such engagement, conversation simulation server 122 may process a text string corresponding to spoken query spoken by the user to identify video content that includes “best” responds to both the words of the text string and the meaning imparted on these words by the text string, as described below in reference to FIG. 5.

FIG. 5 is a flowchart of an exemplary method 500 for identifying video content that matches a content and meaning of a spoken statement, according to disclosed embodiments. In an embodiment, method 500 may provide functionality that enables a server associated with a conversation simulation system (e.g., server 122 of FIG. 1) to parse the received text string, identify a set of candidate queries within configuration data that may correspond to the received text string, and identify video content associated with a candidate query that “best” matches the literal content and contextual meaning of the received text string. Furthermore, as will be apparent to one of skill in the art from the present disclosure, the steps and arrangement of the same in FIG. 5 may be modified, as needed.

In FIG. 5, server 122 may obtain a text string corresponding to a query spoken by a user of a client device (e.g., client device 102). In such embodiments, the statement may correspond to a query spoken within a simulated conversation with a subject (e.g., Dr. Donald Lindberg).

Text strings obtained in step 502 are not limited to spoken queries, and in additional embodiments, the text string may correspond to a command spoken by the user (e.g., a command to stop a simulated conversation), or an answer to a question posed to the user by the subject (e.g., an examination question posed to the user by a prerecorded professor). The disclosed embodiments are, however, not limited to such exemplary spoken statements, and in additional embodiments, the spoken statement be associated with any additional or alternate contextual meaning apparent to one of skill in the art and appropriate to the simulated conversation.

Further, as discussed above, the obtained text string may correspond to a text string received from client device 102, which received and processed the corresponding audio input. Alternatively, the text string may have been received from a speech recognition server (e.g., speech recognition server 112 of FIG. 1), that upon instruction from client device 102, converted an input audio signal into the text string and subsequently transmitted the text string to server 122.

In step 504, server 122 obtains a configuration data that corresponds to a subject of the simulated conversation, for example, from configuration data 124B of data repository 124. As described above, the obtained configuration data may include a plurality of entries that correspond to queries posed to the subject during an interview and that are linked to corresponding video segments that represent the subject's response to the queries. For example, in a simulated conversation with Dr. Donald Lindberg, server 122 would retrieve configuration data for Dr. Lindberg's conversation from configuration data 124B.

Server 122 may subsequently compare the obtained text string against each of the queries within the obtained configuration data in step 506 to determine whether the obtained configuration data includes a query that exactly matches the received text string. If server 122 identifies an exact match in step 506, then server 122 identifies the video segment associated with the exact match as the response to the obtained text string in step 508. For example, as discussed above, the exact match may be associated with a corresponding entry in the configuration data, and server 122 may identify the corresponding video segment based on linking information within the entry (e.g., a pointer to the location of the corresponding video segment within video content 124A, or a file name of the corresponding video segment within video content 124A).

Once server 122 identifies the video segment that includes the response to the obtained text string, and thus, the spoken query, server 122 may output information associated with the identified video segment in step 510. For example, in step 510, server 122 may output a string of text corresponding to the exact-match query and additionally or alternatively, the information identifying the location of the video segment. Method 400 then passes back to step 416 of the exemplary method of FIG. 4, which provides the video segment to the user as a response to the spoken query, and method 400 is subsequently completed in step 512.

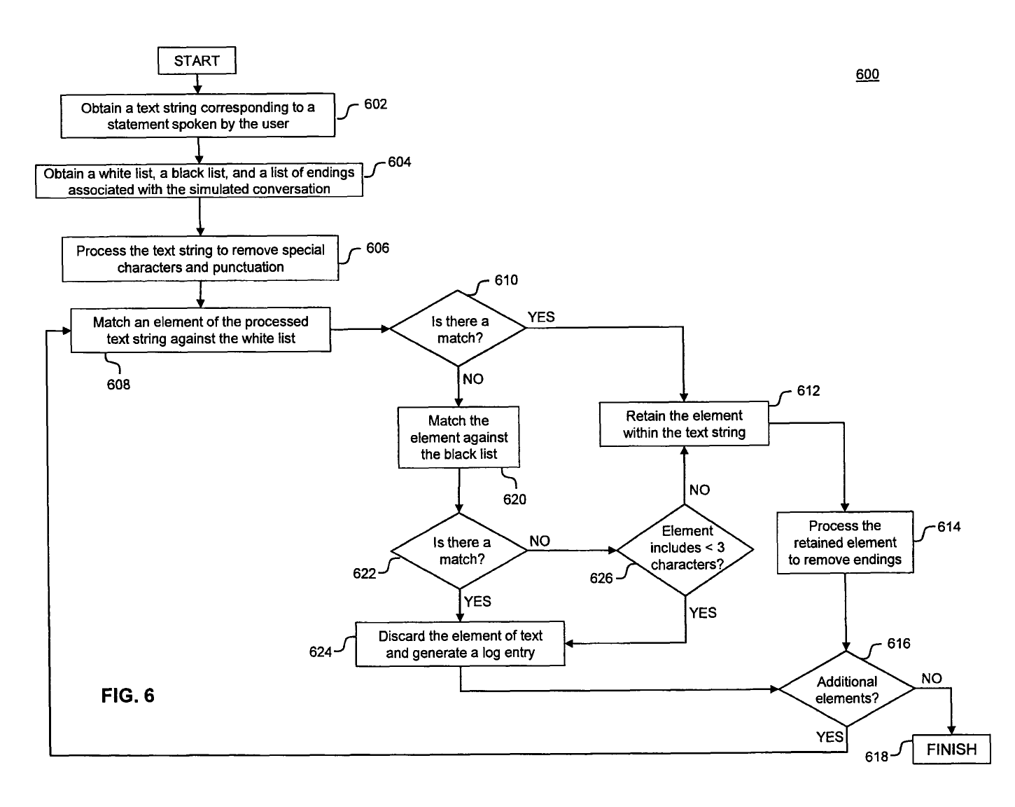

Alternatively, if server 122 fails to identify an exact match for the obtained text string within the configuration data, server 122 may parse the obtained text string within step 514 in accordance with information specified within the configuration data. For example, the obtained text string may be parsed to remove punctuation and special characters, to discard words included within a black list and/or that include three or fewer characters, to maintain words of any length included within a white list, and to remove endings in accordance with an ending list, as outlined below in reference to FIG. 6.

FIG. 6 is a flowchart of an exemplary method 600 for parsing a text string that corresponds to a statement spoken by a user during a simulated conversation, according to disclosed embodiments. In an embodiment, method 600 may provide functionality that enables a conversation simulation server (e.g., server 122 of FIG. 1) to parse a text string in accordance with a set of rules and filters corresponding to the subject of the simulated conversation. Furthermore, as will be apparent to one of skill in the art from the present disclosure, the steps and arrangement of the same in FIG. 6 may be modified, as needed, and further, executed in parallel or non-sequentially.

In FIG. 6, server 122 may obtain a text string in step 602 that corresponds to a statement spoken by a user during a simulated conversation with a prerecorded subject. For example, the statement may correspond to a query spoken within a simulated conversation with the subject, a command spoken by the user during the simulated conversation, and an answer to a question posed to the user by the subject. Server 122 may also obtain, from configuration data associated with the subject (e.g., from within configuration data 124B of FIG. 1), a white list, a black list, and a list of endings associated with the subject in step 604.

In step 606, server 122 may process the obtained text stream to discard special characters and punctuation. In such an embodiment, the exemplary processes of step 606 may remove all characters from the text stream except for capitalized and lower-case letters, Arabic numerals, and spaces. For example, server 122 may process the text string “How long have you been the Director?” to delete the “?” and yield a resulting text string of the form “How long have you been the Director.”

Sever 122 may then select an element of the text string for comparison against the obtained white list (e.g., white list 200 of FIG. 2A) in step 608, and may determine in step 610 whether the selected element matches a corresponding element of white list 200. In the embodiments described herein, an element of a text string or list may represent a single word, one word within a compound word, and additionally or alternatively, a portion of a word associated with a deleted ending.

If server 122 identifies a match between the selected element and an element of the white list in step 610, then the matching element corresponds to an authorized word regardless of its length. Server 122 may then retain the matching element within the text string in step 612, and may subsequently process the retained element in step 614 to discard unnecessary endings. In such embodiments, server 122 may match a grammatical ending (e.g., a suffix) against the obtained list of endings (e.g., endings list 240 of FIG. 2C), and if the suffix matches on the obtained list, the suffix is discarded in step 614.

In step 616, server 122 may then determine whether additional elements of the text string require processing. If server 122 determines that additional elements of the text string require processing, then exemplary method 600 passes back to step 608, and an additional element of the text string is matched against white list 200. Alternatively, if server 122 determines that no additional elements of the text string require processing, then exemplary method 600 is complete and finished in step 618, and the parsed text string is passed back to step 516 of the exemplary method of FIG. 5, which identifies candidate queries within the configuration data that may correspond to the parsed text string.

Referring back to step 610, if server 122 does not identify a match for the selected element of the text string within white list 200, server 122 may the match the selected element against the obtained black list (e.g., black list 220 of FIG. 2B) in step 620. Server 122 then determines in step 622 whether the selected element of the text string matches an element of black list 220.

If server 122 determines that the selected element of the text string matches an element of black list 220, then the selected element corresponds to an unauthorized text string element. In step 624, server 122 discards the unauthorized element and generates a log entry that identifies the discarded element. Exemplary method 600 then passes back to step 616, at which time server 122 determines whether additional elements of the obtained text string require processing, as described above.

Alternatively, if server 122 determines in step 622 that the selected element of the obtained text string fails to match any portion of black list 220, then the selected element is neither automatically retained in the obtained text string nor automatically discarded from the obtained text string. Server 122 then determines in step 626 whether the selected element includes three or fewer characters.

If server 122 determines that the selected element includes three or fewer characters, then the method 600 passes back to step 624, and server 122 discards the selected element from the text string and generates a log entry to identify the discarded element, as described above. Alternatively, if server 122 determines that the selected element includes more than three characters, then method 600 passes back to step 612, and server 122 retains the selected element within the text string, as described above.

For example, using the exemplary processes of FIG. 6, the obtained text string “How long have you been the Director?” may be processed to generate a parsed text string for subsequent matching and scoring. In such an embodiment, the special character “?” may be discarded, the words “How” and “you” are included within white list 200 and may be retained in the text string, the words “have” and “been” are included within black list 220 and may be discarded, and the word “the” may be discarded due to its length. The resulting parsed text string takes the form “How long you director,” and may be passed back to step 510 of exemplary method 500 of FIG. 5, for additional matching and scoring.

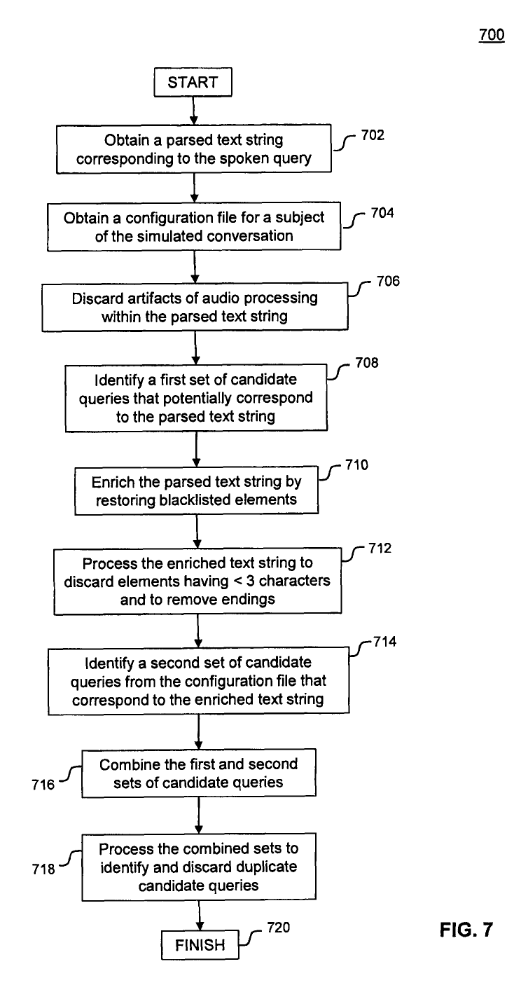

Referring back to FIG. 5, upon generation of the parsed text string in step 514, server 122 may compare the parsed text string against the queries included within the obtained configuration data in step 516 to identify a set of candidate queries that potentially correspond to the parsed text string. For example, the processes of step 516 may identify candidate queries based on (i) matches between discrete words in the parsed text string and corresponding words in the obtained configuration data queries (e.g., the PKWs, CKWs, QKWs, and other unclassified words in the obtained configuration data queries), and additionally or alternatively, (ii) matches between phrases in the parsed text string and corresponding phrases within the obtained configuration data queries (e.g., the PQC combinations, combinations and permutations of the keywords and combinations of synonyms for the keywords, the contiguous phrases, the full-parsed phrases, the P/Q synonym mixes, and the P/C synonym mixes of the obtained configuration data queries), as described below in reference to FIG. 7.

FIG. 7 is a flowchart of an exemplary method 700 for identifying candidate text strings representing potential matches for a parsed text string, according to disclosed embodiments. In an embodiment, method 700 may provide functionality that enables a conversation simulation server (e.g., server 122 of FIG. 1) to identify candidate queries within configuration data of a simulated conversation that match discrete words within a parsed text string and additionally or alternatively, that match discrete phrases within the parsed text string.

In step 702, server 122 obtains a parsed text string that corresponds to a query (or, alternatively, a command or an answer) spoken by a user, and in step 704, server 122 obtains configuration data associated with a simulated conversation of between the user and a subject (e.g., from within configuration data 124B of FIG. 1). In such an embodiment, the parsed text string may be generated from a raw text string using the exemplary techniques of FIG. 6 and as discussed above, the obtained configuration data may include entries associated with corresponding queries or statements posed to the subject during an interview.

Server 122 the processes the parsed text string in step 706 to discard any artifacts that result from audio processing and input techniques. For example, many speech recognition engines (e.g., as executed at client device 102) may register an “on/off” switch of a microphone as at least one of the words “can,” “that,” or “have” within the parsed text string. In step 706, server 122 may process the parsed text string to identify and subsequently discard such invalid “mic click” artifacts.

In step 708, server 122 may compare the parsed text string against the configuration data to identify a first set of candidate queries that potentially correspond to the parsed text string. As described, the configuration data includes a plurality of entries that corresponding, respectively, to queries posed to the subject during an interview process and that include keyword data and synonym data associated with the queries. For example, the keyword data may include, but is not limited to PKWs, CKWs, and QKWs, PQC combinations, contiguous phrases, and full-parsed phrases for the queries, and the synonym data may include, but is not limited to, P/Q synonym mixes and P/C synonym mixes, as defined above.

In such an embodiment, server 122 may identify the first set of candidate queries in step 708 based on matches between discrete words in the parsed text string and corresponding words in the queries (e.g., the PKWs, CKWs, QKWs, and other unclassified words in the obtained configuration data queries), and additionally or alternatively, matches between phrases in the parsed text string and corresponding phrases within the queries (e.g., the PQC combinations, the contiguous phrases, the full-parsed phrases, the P/Q synonym mixes, and the P/C synonym mixes of the obtained configuration data queries).

Upon identification of the first set of candidate queries in step 708, server 122 may subsequently enrich the parsed text string by restoring those elements of the parsed text string that were previously discarded in accordance with a black list (e.g., within step 624 of FIG. 6). In such an embodiment, the enriched text string may expand a pool of candidate queries that potentially match the spoken query, thereby increasing a likelihood that a video segment can be selected to match both the content and meaning of the spoken query,

In an embodiment, server 122 may obtain log entries created during the generation of the parsed text string, and may subsequently identify one or more elements of the text string discarded in accordance with the black list. Server 122 may add these previously-discarded elements to the parsed text string to generate the enriched text string in step 708.

For example, using the exemplary techniques of FIG. 6, log entries may indicate the terms “have” and “been” were discarded from the text string “How long have you been the Director” in accordance with the black list. In such an embodiment, server 122 may enrich the parsed text string “How long you director” in step 710 to include these blacklisted terms to generate the enriched text string “How long have you been Director.”

Referring back to FIG. 7, server 122 may process the enriched text string in step 712 to discard unauthorized terms (e.g., those not included within a corresponding white list) having three or fewer characters and to discard unauthorized endings in accordance with an endings list (e.g., endings list 240 of FIG. 2C). For example, the enriched text string “How long have you been Director” includes no unauthorized words having length of three or fewer characters, and a comparison with endings list 240 causes server 122 to discard the ending “e” from “have” in step 712 to yield the enriched text string “How long hav you been Director.”

In step 714, server 122 may compare the enriched text string against the configuration data to identify a second set of candidate queries that potentially correspond to the enriched text string. Similar to the processes of step 708, server 122 may identify the second set of candidate queries in step 708 based on matches between discrete words in the enriched text string and corresponding words in the queries (e.g., the single-word PKWs, single-word CKWs, single-word QKWs, and other unclassified words in the obtained configuration data queries), and additionally or alternatively, matches between full phrases in the enriched text string and corresponding full phrases within the queries (e.g., the multi-word PKWs, multi-word CKWs, multi-word QKWs, PQC combinations, contiguous phrases, full-parsed phrases, P/Q synonym mixes, and P/C synonym mixes of the obtained configuration data queries).

Server 122 may combine the first and second sets of candidate queries in step 716, and may process the combined sets of candidate queries in step 718 to identify and discard duplicate candidate queries. Exemplary method 700 is subsequently completed in step 720, and the candidate queries may be passed back to step 518 of exemplary method 500 for subsequent scoring.

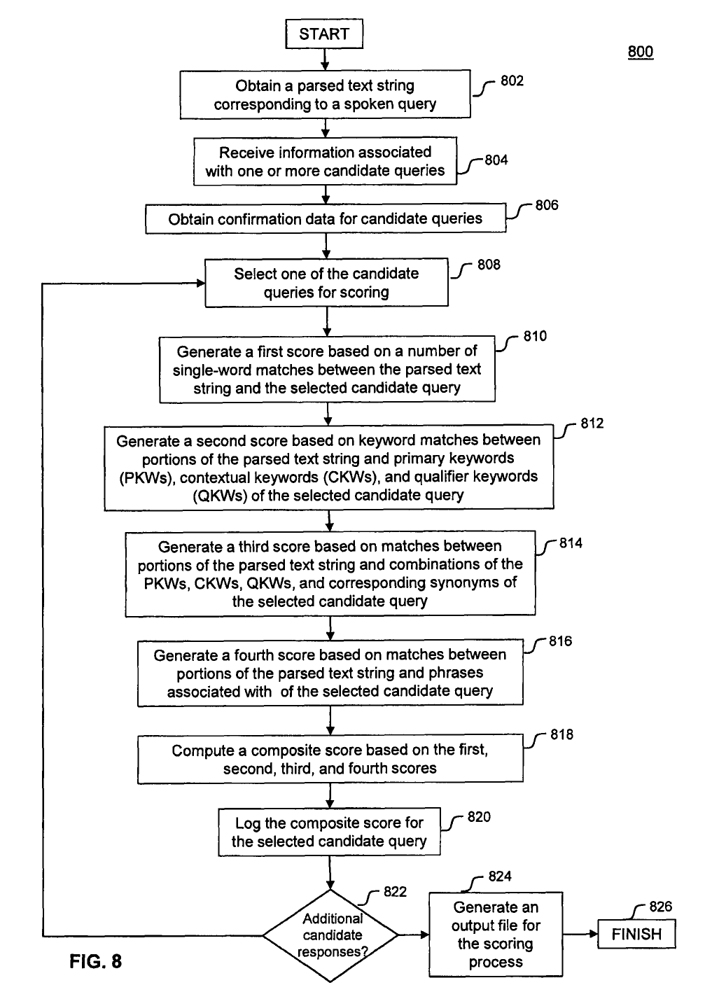

Referring back to FIG. 5, upon identification of the candidate queries in step 516, server 122 may generate scores for the candidate queries in step 518 that are indicative of a degree of correspondence between the candidate queries and the parsed text string, as described below in FIG. 8. In an embodiment, the generates scores based be based on combinations of scores assigned to single-word matches and scores assigned to each word within matching phrases. For example, a single point may be assigned to each single word in a candidate query that matches a corresponding word within the parsed text string, and five points may be assigned to each word within a full phrase of the candidate query that matches a corresponding full phrase of the parsed text string. As described above, such full phrases may include, but are not limited to, multi-word PKWs, multi-word CKWs, multi-word QKWs, PQC combinations, contiguous phrases, full-parsed phrases, P/Q synonym mixes, and P/C synonym mixes of the candidate queries. Further, although described in terms of exemplary point values, the disclosed embodiments are not limited to such exemplary values, and in additional embodiments, the scores assigned to word and/or phrase matches may include any additional or alternate point values apparent to one of skill in the art and appropriate to the candidate queries

Further, as described above, the parsed text string need not correspond to a query spoken by a user, and in additional embodiments, the parsed text string may correspond to a spoken query, or alternatively, a spoken answer to a question posed by a subject of the simulated conversation. In such embodiments, the scoring of candidate commands or answers may proceed in a manner similar to the scoring of candidate queries described above, Further, in such embodiments, a score of a candidate command may be increased by an arbitrary amount, e.g., five points, to account for generally short length of candidate commands, and as such, the generate lower scores assigned to candidate command.

Upon generation of the candidate query scores in step 518, server 122 may select one of the candidate queries that “best” corresponds to the parsed text string in step 520. For example, the “best” candidate query may be that candidate query associated with a maximum score. Further, in such embodiments, server 122 may also select one or more “runner-up” candidate queries associated with scores that fall immediately below the “best” candidate query.

In step 522, server 122 may identify a segment of video content that corresponds to the selected candidate query and additionally or alternatively, with each of the “runner-up” queries. In such an embodiment, server 122 may identify entries in the obtained configuration data that correspond to the selected candidate query, and additionally or alternatively, with each of the “runner-up” queries, and may identify the segments of video linked to the identified entries.

Server 122 may subsequently output information associated with the selected candidate query and the corresponding video segment in step 510. Further, as discussed above, server 122 may output an ordered list of the selected candidate query, runner-up candidate queries, and corresponding video segments in step 510. In such embodiments, if candidate exam answers are dispersed within any of the output candidate queries, these candidate exam answers may be disposed at an initial position within the output list of candidates and corresponding video segments. Method 500 is completed is step 512, and the candidate queries and video segment information may be passed to step 416 of method 400 of FIG. 4, which provides the video segment corresponding to the “best” candidate query to a user within a simulated interactive conversation with a subject.

Using the exemplary methods described above, a user of client device 102 may engage in an interactive, simulated conversation with a pre-recorded subject that preserves a fidelity associated with person-to person conversations. To facilitate such engagement, conversation simulation server 122 may identify candidate responses to queries, commands, and answers spoken by the user based on scores assigned to candidate responses in accordance with combinations and permutations of primary keyword data, qualifier keyword data, contextual keyword data, and corresponding synonyms, as described below in reference to FIG. 8.

FIG. 8 is a flowchart of an exemplary method 800 for generating scores for candidate queries, according to disclosed embodiments. In an embodiment, method 800 may provide functionality that enables a conversation simulation server (e.g., server 122 of FIG. 1) to compute scores for a set of candidate queries based on matches between a text string and combinations and permutations of primary keyword data, qualifier keyword data, contextual keyword data, and corresponding synonyms associated with the candidate queries.

In step 802, server 122 obtains a parsed text string that corresponds to a query (or, alternatively, a command or an answer) spoken by a user, and in step 804, server 122 may obtain a set of candidate queries that may represent potential matches for the parsed text string. In such an embodiment, the parsed text string may be generated from a raw text string using the exemplary techniques of FIG. 6, and the candidate queries may be identified from configuration data associated with the subject of the simulated conversation using the exemplary techniques of FIG. 7.

In step 806, server 122 obtains configuration data associated with the obtained candidate queries. For example, the configuration data for the candidate entries may be obtained from the configuration data associated with the subject of the simulated conversation, which may be stored within configuration data 124B of data repository 124 of FIG. 1. Further, as discussed above, the configuration data for the candidate queries may identify corresponding segments of video content that include recorded responses of the subject to the corresponding candidate queries. Further, each entry may also include keyword data derived from corresponding ones of the candidate queries and synonym data associated with the keyword data.

In such embodiments, and as described above in reference to FIG. 1, the keyword data may include, but is not limited to, primary keywords or phrases (i.e., PKWs) that reveal topics or themes associated with the candidate queries considered by the subject, qualifier keywords or phrases (i.e., QKWs) that clarify intentions associated with the PKWs and that enable the subject to more fully answer the candidate queries, contextual keywords or phrases (i.e., CKWs) that define boundaries of the candidate queries and that may increase a precision with which the subject understands the candidate queries, combinations of the words and phrases of the corresponding PKWs, QKWs, and/or CKWs (i.e., PQC combinations), contiguous phrases that include the PKWs and the words disposed immediately before and after the PKW in the candidate queries, full-parsed phrases that include processed portions of the candidate queries, and perturbations and combinations thereof.

Further, in such embodiments, the synonym data may include, but is not limited to, combinations and permutations of synonyms of the PKWs and CKWs of the corresponding candidate queries (i.e., P/C synonym mixes) and combinations of synonyms of the PKWs and QKWs of the particular corresponding candidate queries (i.e., P/Q synonym mixes). Using the exemplary techniques of FIG. 8, server 122 may generate scores for corresponding ones of the candidate queries that indicate a degree of correspondence between the candidate queries and a meaning imparted by a user on a freely-spoken query upon which the parsed text string is based.

Referring back to FIG. 8, server 122 selects one of the candidate queries for scoring in step 808, and a first score is subsequently generated by server 122 in step 810 based on a number of single-word matched between the text of the selected candidate query and the parsed text string. In an exemplary embodiment, server 122 may assign a point value of unity to each single-word match identified step 810 and may sum the assigned point values to generate the first score.

For example, a user of a client device (e.g., client device 102 of FIG. 1) may be participating in an interactive, simulated conversation with Dr. Donald Lindberg. In such an exemplary implementation, the user may speak into a microphone or other audio input device associated with client device 102 (e.g., audio input device 104 of FIG. 1) a query to Dr. Lindberg regarding his tenure at the NLM, which server 122 may process to generate the parsed text string “How long hav you been the director.”

Further, for example, in step 808, server 122 may select the candidate query “How long have you been the director” for subsequent scoring. In step 810, server 122 may determine that seven elements within the parsed text string match corresponding elements of the selected candidate query (e.g., “been,” “director,” “hav,” “How,” “long,” “the,” and “you”), and accordingly, server 122 may assign a first score of seven to the selected candidate query.

Referring back to FIG. 8, server 122 may assign a second score to the selected candidate query in step 812 based on, for example, matches between elements of the parsed text string and at least one of a PKW, a CKW, or a QKW of the selected candidate query. In an exemplary embodiment, server 122 may assign a point value of five to each word within the matched PKW, CKW, and QKW identified in step 812, and may sum the assigned point values to generate the second score.

For example, when the selected candidate query corresponds to “How long have you been the director,” the PKW of the selected candidate query may be “Director,” and QKWs of the form “How long” and “long” may be associated with the selected candidate query. Furthermore, the exemplary selected candidate query is not associated with a corresponding CKW, although in additional embodiments, a selected candidate query may be associated with one or more CKWs that include words and/or phrases.

Under these exemplary circumstances, the PKW and both QKWs match corresponding portions of the parsed text string, and as such, server 122 may assign five points for the PKW match and fifteen points for the three words of the QKW match. Server 122 may then sum the individual PKW and QKW scores to generate a second score of twenty.

In FIG. 8, server 122 may generate a third score for the selected candidate query in step 814 based on matches between portions of the parsed text string and combinations of the PKWs, CKWs, QKWs, and corresponding synonyms of the selected candidate query and permutations of the combinations. For example, each synonym of the PKW (or each synonym of the words in the PKW) may be combined with each synonym of the QKW (or each synonym of the words in the QKW) to generate a list of P-Q combinations (e.g., a P-Q line). Similarly, for example, each synonym of the PKW (or each synonym of the words in the PKW) may be also combined with each synonym of the CKW (or each synonym of the words in the CKW) to generate a list of P-C combinations (e.g., a P-C line).

In an exemplary embodiment, server 122 may match the recognized words against each combination of the PKWs, CKWs, QKWs, and further, against each combination of within the P-Q line and the P-C line. Additionally or alternatively. server 122 may also match the recognized words against one or more permutations of the combination of the PKWs, CKWs, QKWs, and/or against one or more permutations of the P-Q line combinations and the P-C line combinations. Server 122 may assign a point value of five to each word within the matched combinations and matched permutations, and may sum the assigned point values to generate the third score. In such embodiments, by comparing the recognized words against both combinations and permutations of the keyword data and synonym data, server 122 may estimate the intention of the user's spoken phrase, provide an immediate, precise, relevant response, and facilitate sustained, free-speech conversation of unlimited duration between a human being and a machine.

For example, using the exemplary selected candidate query identified above, server 122 identified a match between a PQC combination of the selected candidate query (i.e., “How long director’) and corresponding portions of the parsed text string. Server 122 may assign a third score of fifteen to the selected candidate query, as no synonym matches were evident and no CKW was present within the exemplary selected candidate query.

Referring back to FIG. 8, In FIG. 8, server 122 may generate a fourth score for the selected candidate query in step 816 based on matches between portions of the parsed text string and phrases associated with of the selected candidate query. For example, such phrases may include, but are not limited to, contiguous phrases that include the PKW and the words disposed immediately before and after the PKW in the selected candidate queries, and full-parsed phrases that include processed portions of the selected candidate query. In an exemplary embodiment, server 122 may assign a point value of five to each word within the matching phrases identified in step 814, and may sum the assigned point values to generate the fourth score.

For example, using the exemplary selected candidate query identified above, server 122 may identify matches within the parsed text string for contiguous phrases “been the Director,” “been Director,” and “the Director” within the selected candidate query. Server 122 may then identify seven words within the matched contiguous phrases and may assign a word score of thirty-five to the matched contiguous phrases.

Further, server 122 may identify matches within the parsed text string for full-parsed phrases “How long hav you been the Director,” “you Director,” “hav Director,” “long Director,” and “How Director” associated with the selected candidate query. Server 122 may then identify fifteen words within the matched full-parsed phrases and may assign a word score of seventy-five to the matched full-parsed phrases. Server 122 may subsequently compute a fourth score of 110.

Referring back to FIG. 8, server 122 computes a composite score for the selected candidate phrase by summing the first, second, third, and fourth scores. For example, using the exemplary candidate query “How long have you been the director,” server 122 may compute a composite score of 152. Server 122 may subsequent generate a log entry in step 820 that, for example, records the composite score assigned to the selected candidate, records the constituent scores that form the composite score, and that identify the word and phrases matched between the selected candidate query and the parsed text string.

Server 122 then determines in step 822 whether additional candidate queries require scoring, and if so, method 800 passes back to step 808, which select an additional candidate query for scoring. If, however, server 122 were to determine that no additional candidate queries require scoring in step 822, then server 122 may generate an output file that provides details on the scoring process in step 824. Exemplary method 800 is complete in step 826, and the details on the scoring process passed back to step 514 of exemplary method 500, which enables server 122 to select candidate query that corresponds to the parsed text string.

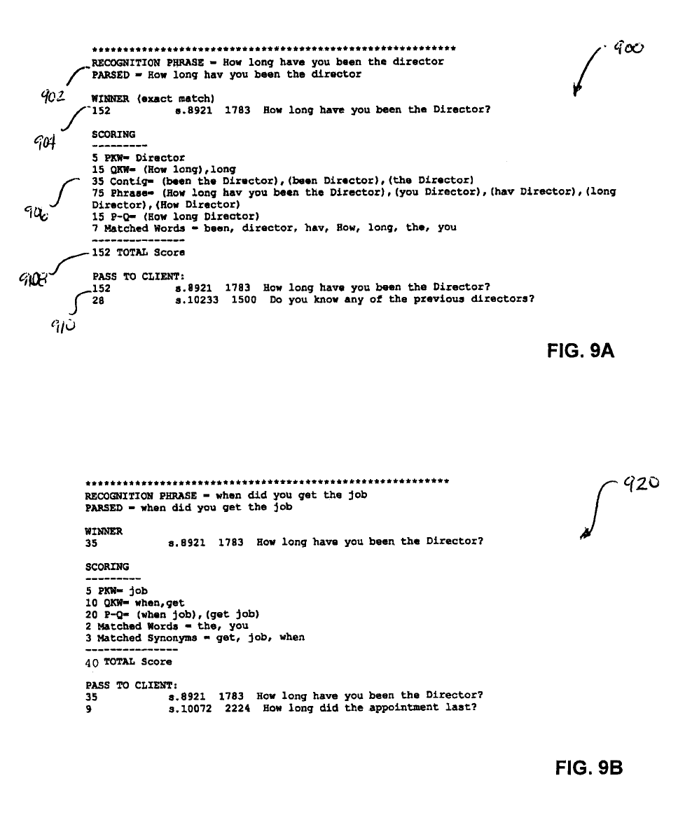

FIG. 9A illustrates an exemplary output file 900 describing details of a scoring process for a parsed text string, according to disclosed embodiments. In FIG. 9A, output file 900 includes information 902 identifying the raw text string “How long have you been the director” and the corresponding parsed text string “How long hav you been the director.” Winner 904 indicates that candidate query “How long have you been the Director,” which is associated with a video segment having a pointer of “s.8921” within video content 124A of FIG. 1, is associated with the highest composite score. Scoring details 906 indicate a breakdown of the first, second, third, and fourth scores described above, and total score 908 identifies a total score of 152 associated with the winning candidate query. Query list 910 provides information identifying the winning candidate query, and one or more runner-up candidate queries that, in an embodiment, may be passed back to step 514 of exemplary method 500, which selects the candidate query that “best” matches both a lateral content of the parsed text string and a meaning imparted by the user on the spoken query corresponding to a text string.

In an embodiment, information within output file 900 may be passed directed to client device 102 as a text file, and additionally or alternatively may be displayed to a user or an administrator within a window of a debugging application associated with conversation simulation server 122. Further in additional embodiments, information associated with query list 910, e.g., the points to the corresponding video content, may be passed to client device 102 in text form, in comma delimited form, or in any additional for alternate form apparent to a person of skill in the art and appropriate to server 122 and client device 102.

Further, as described above, candidate queries identified within configuration data for a subject of a simulated conversation may represent grammatically-correct “pristine” question posed to the subject by an interviewer. In such an embodiment, a user at a client device may have no information regarding such pristine questions posed to a subject, and the user may freely pose questions to the subject of the simulated conversation based on the user's interests and topics discussed by the subjects. As described below, the exemplary processes of FIG. 8 may leverage the combinations of keywords and keyword synonyms to identify candidate queries that are consistent with an intended meaning of “free speech” queries uttered utterances by the user.

For example, during a simulated conversation with Dr. Donald Lindberg, the user may utter a query of the form “when did you get the job,” which server 122 may parse to generate a parsed text string of identical form. Using the exemplary candidate query “how long have you been the director,” as discussed above, server 122 may identify a corresponding PKW of “Director,” and corresponding QKWs of “How long” and “long.” Furthermore, server 122 may identify a PKW synonym “job,” and QKW synonyms of “when” and “get.”

In such an exemplary embodiment, and using the processes of FIG. 8, server 122 may generate a first score of five for the candidate query in step 810, which corresponds to two matched words (e.g., “the” and “you”) and three matched synonyms (e.g., “get,” “job”, and “when”). A second score of fifteen may be generated by server 122 in step 812, which corresponds to a match with the PKW synonym “job” and two QKW synonyms “when” and “get.” Further, in step 814, server 122 may generate a third score of twenty for matches between combinations of the PKW and QKW synonyms (e.g., “when job” and “get job”). As no phrases in the candidate query match corresponding phrases in the parsed text string, server 122 assigns a fourth score of zero to the candidate query.

In step 828, server 122 computes a composite score for candidate query “how long have you been the director” of forty, and as outlined in output file 940 of FIG. 9B, the candidate query represents a “winning” query. Accordingly, using the embodiments described above, server 122 may identify a candidate query, and as such, a corresponding video response from Dr. Lindberg, that matches a meaning imparted by the user onto a spoken query, while allowing the language of the user's freely-spoken query to differ substantially from the winning candidate query.

In the embodiments described above, reference is made to freely-spoken queries, parsed text strings that correspond to these freely-spoken queries, and processes that identify segments of pre-recorded video content that include answers to these freely-spoken queries. The disclosed embodiments are not limited to queries spoken by a user and answered by a pre-recorded subject of a simulated conversation. In additional embodiments, the exemplary methods described above may enable a server associated with a conversation simulation engine (e.g., server 122 of FIG. 1) to identify segments of pre-recorded video content and to generate instructions to execute appropriate actions in response to a freely-spoken command within an interactive simulated conversation (e.g., a command to terminate the session). Additionally or alternatively, the exemplary methods described above may enable the user to verbalize answers to queries posed by the subject of the interactive simulated conversation, and to subsequent identify and present to the user additional segments of pre-recorded video content that respond to the spoken answer.

In the embodiments described above, users may participate in interactive, simulated conversations with pre-recorded video segments representative of eminent scientists, politicians, and educators. The disclosed embodiments are not limited to such exemplary subjects, and in additional embodiments, subjects of the interactive simulated conversations may include participants in events of cultural significance (e.g., Holocaust survivors and participants in the civil rights marches of the 1960s), individuals having practical or specialized experience of interest to a community (e.g., physicians, engineers, mathematicians, and mechanics), elderly relatives, and any additional or alternate individuals whose experience or practical knowledge is of interest to the user of client device 102.

Furthermore, in additional embodiments, the interactive simulated conversations may be directed to practical scenarios and circumstances. For example, a scientist at a remote station may initiate an interactive dialog with pre-recorded images of a physician or nurse-practitioner to diagnose or treat a malady. Further, for example, a worker manning an oil rig may enter into a simulated conversation with a petroleum engineer to diagnose and repair a significant mechanical or electrical problem for which the worker lacks the requisite knowledge.

In addition, the embodiments described above enable a user to converse freely and interact with a pre-recorded subject within an interactive, simulated conversation. The disclosed embodiments are not limited to such exemplary simulated conversations, and in additional embodiments, the exemplary methods described above may be leveraged by additional applications to identify content (or to enhance previously-identified content) that corresponds not only to the literal content of a spoken statement, but also to the meaning imparted on that spoken statement by a user. For example, the exemplary parsing, matching, and scoring processes described above may be implemented by a search engine (e.g., Google and Microsoft Bing) to identify search results consistent with a meaning associated with a spoken search query (e.g., as received and converted to text by Microsoft Speech Recognition Engine or Siri by Apple).

Various embodiments have been described herein with reference to the accompanying drawings. It will, however, be evident that various modifications and changes may be made thereto, and additional embodiments may be implemented, without departing from the broader scope of the invention as set forth in the claims that follow.

Further, other embodiments will be apparent to those skilled in the art from consideration of the specification and practice of one or more embodiments of the present disclosure. It is intended, therefore, that this disclosure and the examples herein be considered as exemplary only, with a true scope and spirit of the invention being indicated by the following listing of exemplary claims.

What is claimed is:

1. A computer-implemented method for simulating an interactive conversation with a recorded subject, comprising:
receiving a text string corresponding to a query spoken by a user during the interactive conversation;
obtaining information associated with a plurality of candidate queries posed to the recorded subject, the information comprising:
keyword data associated with the candidate queries, the keyword data comprising, for corresponding ones of the candidate queries, at least a primary keyword; and
synonym data comprising a synonym for the primary keyword;
using at least one processor, generating scores for the candidate queries based on the text string and at least one of the keyword data or the synonym data, the candidate query scores being indicative of a correspondence between a portion of the text string and the candidate queries;
selecting, based on the candidate query scores, one of the candidate queries that corresponds to the text string, the selected candidate query being associated with video content that includes a response to the spoken query by the recorded subject.

2. The method of claim 1, further comprising generating an instruction to provide at least one of the video content or information associated with the video content to the user.

3. The method of claim 1, further comprising:
filtering the received text string in accordance with at least one of a white list of authorized terms. a black list of prohibited terms, or a list of prohibited endings; and
generating scores for the candidate queries based on the filtered text string and at least one of the keyword data or the synonym data.

4. The method of claim 3, wherein the filtering further comprises:
identifying a term within the received text string that includes three of fewer characters;
determining whether the white list includes the identified term; and
discarding the identified term from the received text string, when the white list does not include the identified term.

5. The method of claim 4, wherein the filtering further comprises maintaining the identified term within the received text string, when the white list includes the identified term.

6. The method of claim 1, wherein the generating further comprises:
determining, for the candidate queries, numbers of elements within the text string that match corresponding elements within the candidate queries; and
computing the scores for the candidate queries based on the determined numbers.

7. The method of claim 1, wherein the generating further comprises:
identifying elements within the text string that match at least one of the primary keyword, the contextual keyword, or the qualifier keyword associated with corresponding ones of the candidate queries; and
computing the scores for the candidate queries based on at least the identified elements.

8. The method of claim 1, wherein the generating comprises:
identifying elements within the text string that match the synonyms for at least one of the primary keyword, the contextual keyword, or the qualifier keyword associated with corresponding ones of the candidate queries; and
computing the scores for the candidate queries based on at least the identified elements.

9. The method of claim 1, wherein the generating comprises:
identifying portions of the text string that match a combination of the primary keyword and at least one of the contextual keyword or the qualifier keyword associated with corresponding ones of the candidate queries;
computing the scores for the candidate queries based on at least the identified elements.

10. The method of claim 1, wherein the generating comprises:
identifying portions of the text string that match corresponding portions of the candidate queries, the corresponding portions including the primary keywords of the candidate queries; and
computing the scores for the candidate queries based on at least the identified elements.

11. The method of claim 1, wherein:
the keyword data comprises the primary keyword and at least one of a contextual keyword or a qualifier keyword associated with the primary keyword; and
the synonym data comprises a synonym for at least one of the primary keyword, the contextual keyword and the qualifier keyword.

12. An apparatus, comprising:
a storage device; and
at least one processor coupled to the storage device, wherein the storage device stores a program for controlling the at least one processor, and wherein the at least one processor, being operative with the program, is configured to:
receive a text string corresponding to a query spoken by a user during the interactive conversation;
obtain information associated with a plurality of candidate queries posed to the recorded subject, the information comprising:
keyword data associated with the candidate queries, the keyword data comprising, for corresponding ones of the candidate queries, at least one primary keyword; and
synonym data comprising a synonym for the primary keyword;
generate scores for the candidate queries based on the text string and at least one of the keyword data or the synonym data, the candidate query scores being indicative of a correspondence between a portion of the text string and the candidate queries;
select, based on the candidate query scores, one of the candidate queries that corresponds to the text string, the selected candidate query being associated with video content that includes a response to the spoken query by the recorded subject.

13. The apparatus of claim 12, wherein the processor is further configured to:
filter the received text string in accordance with at least one of a white list of authorized terms. a black list of prohibited terms, or a list of prohibited endings; and
generate scores for the candidate queries based on the filtered text string and at least one of the keyword data or the synonym data.

14. The apparatus of claim 13, wherein the processor is further configured to:
identify a term within the received text string that includes three of fewer characters;
determine whether the white list includes the identified term; and
discard the identified term from the received text string, when the white list does not include the identified term.

15. The apparatus of claim 14, wherein the processor is further configured to maintain the identified term within the received text string, when the white list includes the identified term.

16. The apparatus of claim 12, wherein the processor is further configured to:
determine, for the candidate queries, numbers of elements within the text string that match corresponding elements within the candidate queries; and
compute the scores for the candidate queries based on the determined numbers.

17. The apparatus of claim 12, wherein the processor is further configured to:
identify elements within the text string that match at least one of the primary keyword, the contextual keyword, or the qualifier keyword associated with corresponding ones of the candidate queries; and
compute the scores for the candidate queries based on at least the identified elements.

18. The apparatus of claim 12, wherein the processor is further configured to:
identify elements within the text string that match the synonyms for at least one of the primary keyword, the contextual keyword, or the qualifier keyword associated with corresponding ones of the candidate queries; and
compute the scores for the candidate queries based on at least the identified elements.

19. The apparatus of claim 12, wherein the processor is further configured to:
identify portions of the text string that match a combination of the primary keyword and at least one of the contextual keyword or the qualifier keyword associated with corresponding ones of the candidate queries;
compute the scores for the candidate queries based on at least the identified portions.

20. The apparatus of claim 12, wherein the processor is further configured to:
identify portions of the text string that match corresponding portions of the candidate queries, the corresponding portions including the primary keywords of the candidate queries; and
compute the scores for the candidate queries based on at least the identified portions.

21. The apparatus of claim 12, wherein:
the keyword data comprises the primary keyword and at least one of a contextual keyword or a qualifier keyword associated with the primary keyword; and
the synonym data comprises a synonym for at least one of the primary keyword, the contextual keyword and the qualifier keyword.

22. A tangible, non-transitory computer-readable medium storing instructions that, when executed by at least one processor, perform a method for simulating an interactive conversation with a recorded subject, the method comprising the steps of:
receiving a text string corresponding to a query spoken by a user during the interactive conversation;
obtaining information associated with a plurality of candidate queries posed to the recorded subject, the information comprising:
keyword data associated with the candidate queries, the keyword data comprising, for corresponding ones of the candidate queries, at least a primary keyword; and
synonym data comprising a synonym for the primary keyword;
generating scores for the candidate queries based on the text string and at least one of the keyword data or the synonym data, the candidate query scores being indicative of a correspondence between a portion of the test string and the candidate queries; and
selecting, based on the candidate query scores, one of the candidate queries that corresponds to the text string, the selected candidate query being associated with video content that includes a response to the spoken query by the recorded subject.
